(19) United States
(12) Patent Application Publication
(10) Pub. No.: US 2004/0139581 A1
(43) Pub. Date: Jul. 22, 2004

(54) Rotation hinge module with two degree of freedom

(76) Inventor: Dui-Ming Tsai, Tai Shan Hsiang (TW)

Correspondence Address: RABIN & BERDO, P.C., Suite 500, 1101 14th Street, N.W., Washington, DC, 20005, US

(21) Appl. No.: 10/445,837

(22) Filed: May 28, 2003

(30) Foreign Application Priority Data
Jan. 16, 2003 (TW) 92200811

(51) Int. Cl. E05D 3/06

(52) U.S. Cl. 16/366

(57) ABSTRACT

A rotation hinge module with angular fixing structure is employed to connect a mainframe and a display module of a notebook computer. The rotation hinge module has a support base, an elastic means, a steel ball, a ball cover, and a rotation top. The support base mounted on the mainframe has at least a support structure. The elastic means located in the support base supports the steel ball. The ball cover has a hole smaller than the steel ball. The steel ball is exposed to fit in the slot in the rotation top in order to provide an angular fixing function.

### BACKGROUND OF THE INVENTION

1. Field of Invention

The present invention relates to a rotation hinge module. More particularly, the present invention relates to a rotation hinge module with an angular fixing structure.

2. Description of Related Art

As optical and semiconductor manufacturing technology advances, Liquid Crystal Display (hereafter LCD) is widely used in all kinds of electronic appliances. LCD has several advantages, such as high resolution, small volume, light weight, low driving voltage, low power consumption and wide application. Thus, LCD application has become popular in portable TVs, cellular phones, camcorders, notebook PCs, desktop PCs, projectors and other consumer electronics or computer products. LCD has become a mainstream in the display market.

Generally speaking, an LCD is secured to an upper cover of a notebook PC. The upper cover can be opened while turning on the notebook PC. An LCD is exposed after opening the upper cover. The upper cover is connected pivotally to a mainframe of the notebook PC. Therefore, The LCD can be adjusted to a desired position by rotating the upper cover in relation to the mainframe.

Because a notebook PC is portable, a user often carries it out of the office to a desired place. In different circumstances, the notebook PC is needed for demonstration purposes. However, the LCD of notebook PC often doesn't have an ability to display information to all the people around it. Moreover, new PC operation systems can provide a manual input function. Thus, a new model PC entitled Tablet Personal Computer has been introduced to the market. A Tablet Personal Computer (hereafter tablet PC) providing both keyboard input and manual input not only changes computer use habits but also creates a milestone for information technology. A tablet PC has a user-friendly manual input interface and a 180-degree rotatable LCD module. Therefore, persons around the tablet PC can easily read the information displayed on the LCD by rotating the LCD module.

The LCD module's two degrees of rotation function may cause the LCD module to shake or give rise to other unsteady circumstances. Therefore, how to conduct angular fixing of the LCD module after moving the same to a desired position is essential. For the forgoing reasons, there is a need for providing a reliable input and display environment.

### SUMMARY OF THE INVENTION

It is therefore an objective of the present invention to provide a rotation hinge module with an angular fixing function. The rotation hinge module is employed to connect a mainframe and a display module of a notebook computer

In accordance with the foregoing and other objectives of the present invention, a rotation hinge module with an angular fixing structure is employed to connect a mainframe and a display module of a notebook computer. The rotation hinge module comprises a support base, an elastic means, a steel ball, a ball cover, and a rotation top. The support base mounted on the mainframe has at least a support structure. The elastic means located in the support base supports the steel ball. The ball cover has an opening smaller than the steel ball. The steel ball is exposed to fit in a ball slot in the rotation top in order to provide the angular fixing function.

In accordance with one preferred embodiments of the invention, a diameter of the opening of the ball cover is less than a diameter of the steel ball. Thus, the steel ball is partially exposed by the ball cover and cannot slip out of the ball cover. The rotation top further comprises another rotation hinge to connect to the display module.

In accordance with one preferred embodiments of the invention, the rotation hinge module further comprises an upper friction ring and a lower friction ring, respectively fixed to the support base and the rotation top. The support base and the rotation top can rotate in relation to each other while connecting.

In conclusion, the preferred embodiment of the invention has two rotation hinges. One of two rotation hinges has an angular fixing function to provide a steady input and display environment.

It is to be understood that both the foregoing general description and the following detailed description are examples only, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A illustrates a perspective view of a rotation hinge module according to one preferred embodiment of this invention;

FIG. 1B illustrates a bottom view of a rotation hinge module according to one preferred embodiment of this invention;

FIG. 2 illustrates a detailed view of a rotation hinge module according to one preferred embodiment of this invention;

FIG. 3A illustrates a top view of a rotation hinge module according to one preferred embodiment of this invention;

FIG. 3B illustrates a cross-sectional view of a rotation hinge module according to one preferred embodiment of this invention;

FIG. 3C illustrates a side view of a rotation hinge module according to one preferred embodiment of this invention; and

FIG. 4 illustrates an exploded view of a rotation hinge module according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

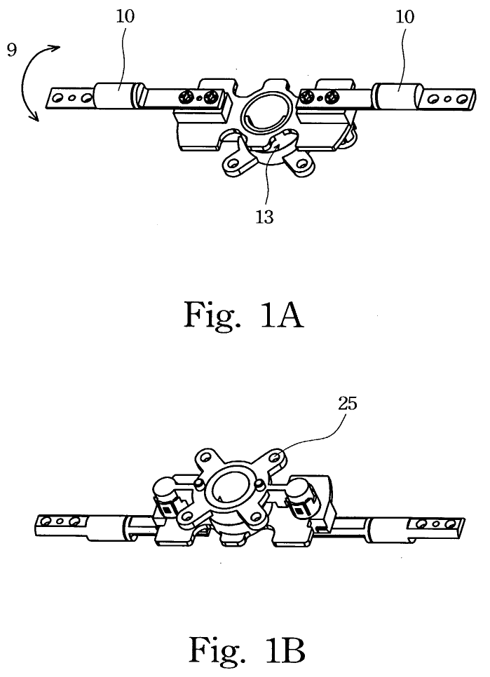

FIG. 1A illustrates a perspective view of a rotation hinge module according to one preferred embodiment of this invention. FIG. 1B illustrates a bottom view of a rotation hinge module according to one preferred embodiment of this invention. The rotation hinge module has two degrees of freedom: a first dimension rotation hinge 10 and a second dimension rotation hinge 13. The rotation hinge 10 provides an open and close function for a LCD module according to rotation direction 9. The rotation hinge 13 provides the LCD module with different viewing angles. Referring to FIG. 1B, several fixing parts 25, such as holes 25, on the back of the rotation hinge module are employed to fasten the rotation hinge module to a mainframe of a notebook PC.

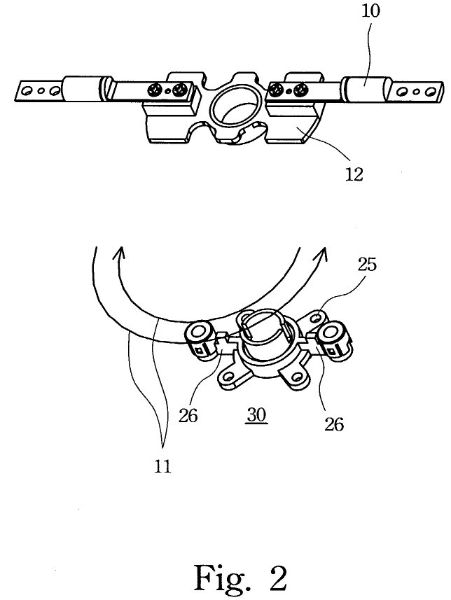

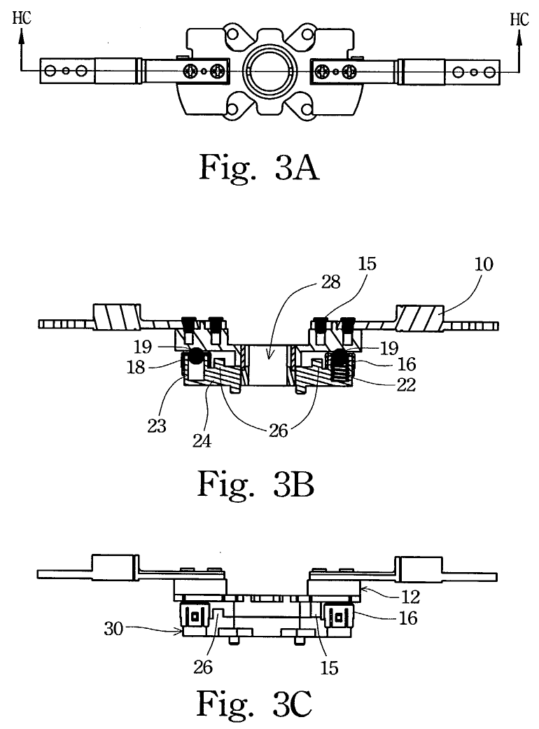

FIG. 2 illustrates a detailed view of a rotation hinge module according to one preferred embodiment of this invention. The rotation hinge module is divided into a rotation top 12 and a support base module 30. The support base module 30 is fixed to a mainframe of a notebook computer. The fixing parts, such as holes 25, are employed for fastening. The rotation top 12 is connected to the support base module 30, and both of them can rotate in relation to each other. A rotation direction 11 can be clockwise or counter clockwise. The rotation hinge 10 fixed to the rotation top 12 is employed to connect with an LCD module of a notebook PC. The support base module 30 has a blocker 26, and the rotation top 12 has a positioner 15 (Referring to FIG. 3C).

FIG. 3A illustrates a top view of a rotation hinge module according to one preferred embodiment of this invention. FIG. 3B illustrates a cross-sectional view of an angular fixing structure. This cross-sectional is taken along line HC in FIG. 3A. The angular fixing structure comprises a support base 24, a support structure 23, an elastic means 22, a steel ball 18, and a ball cover 16. The purpose of the angular fixing structure is to provide an angular fixing function. An LCD module is accordingly fixed and steady such that a stylus can be used to input or to launch an application easily.

Referring to FIG. 3B again, the angular fixing structure can provide an angular fixing function by the forces of the elastic means 22, connected to the support structure 23. The steel ball 18 can fit and support the steel ball slot 19 of the rotation top 12. The angular fixing structure further comprises a steel ball cover 16, having an opening, such as a circular opening. The steel ball cover 16 covers the steel ball 18 and partially exposes the steel ball 18 through the circular opening. The size of the opening is smaller than a diameter of the steel ball 18. That is, a diameter of the circular opening is smaller than a diameter of the steel ball 18. Thus, the steel ball 18 can be partially exposed by the steel ball cover 16 and cannot slip out of the angular fixing structure. In addition, an opening 28 in the center of the angular fixing structure can provide layout space for a power line and an electrical line, employed to electrically connect with the LCD and the mainframe of a notebook PC.

Referring to FIG. 3C, the support base module 30 and the rotation top 12 have a blocker 26 and a positioner 15, respectively. When the rotation top 12 rotates in relation to the support base module 30 according to rotation direction 11 (as shown in FIG. 2). Because the blocker 26 in the support base module 30 limits the positioner 15 in the rotation top 12 when the support base module 30 rotates, the rotation top 12 can rotate in a predetermined angular range (such as 180 degrees). Limiting rotating angular range can prevent power lines and electrical lines in the opening 28 from being damaged because of line twisting.

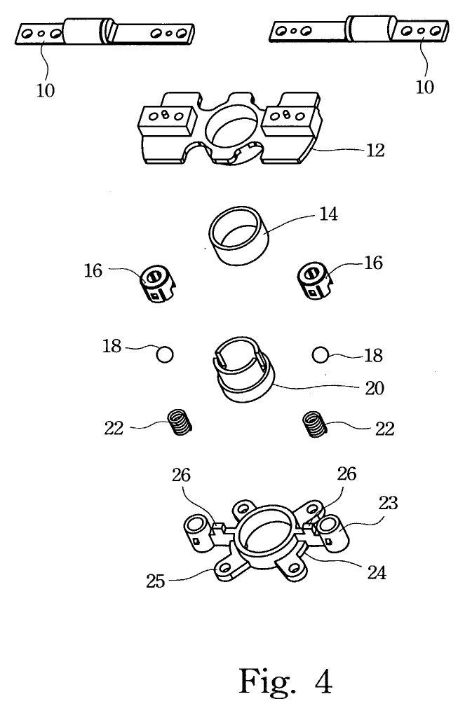

FIG. 4 illustrates an exploded view of a rotation hinge module according to one preferred embodiment of this invention. Referring to FIG. 4, the rotation hinge module comprises a support base 24, a support structure 23, an elastic means 22, a steel ball 18, a ball cover 16, a rotation top 12, an upper friction ring 14, a lower friction ring 20, and a rotation hinge 10. There are two support structures 23 on two sides of the support base 24. The elastic means 22 is located inside a circular slot of the support structure 23. The elastic means 22 can be a spring, a metal elastic means, or a plastic elastic means. The steel ball 18 is put on top of the elastic means 22, and is assembled in the support structures 23 with the ball cover 16. Moreover, a blocker 26 is located on the support base 24, and the blocker 26 is located beside the support structures 23. The location of the blocker 26 is nearer the center of the support base 24 than the support structures 23. The blocker 26 is employed to limit a rotation range of the rotation top 12 in the rotation direction 11. The upper fiction ring 14 and the lower fiction ring 20 are respectively fixed to the rotation top 12 and the support base 24.

According to the preferred embodiment of the invention, the rotation hinge module has two rotation hinges. One of two rotation hinges has an angular fixing function to provide a steady input and display environment.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A rotation hinge module with an angular fixing function is employed to connect a mainframe and a display module of a notebook computer, said rotation hinge module comprising:
a support base, fixed to said mainframe;
an elastic means, connected to said support base;
a steel ball, located on said elastic means;
a ball cover, disposed over said steel ball, and said steel ball partially exposed by said ball cover; and
a rotation top, connected to said support base, said rotation top having a steel ball slot supported by said partially exposed steel ball.

2. The rotation hinge module of claim 1, wherein a diameter of said opening is smaller than a diameter of said steel ball.

3. The rotation hinge module of claim 1, wherein said rotation top further comprises another rotation hinge to connect with said display module.

4. The rotation hinge module of claim 1, further comprising an upper friction ring and a lower friction ring, respectively fixed to said support base and said rotation top.

5. The rotation hinge module of claim 1, wherein said support base further comprises a plurality of holes for fastening.

6. The rotation hinge module of claim 1, wherein said support base further comprises a blocker and said rotation top further comprises a positioner, said rotation top having a rotation range in relation to said support base because said blocker limits said positioner.

7. A rotation hinge module with angular fixing function employed to connect a mainframe and a display module of a notebook computer, said rotation hinge module comprising:
a support base, fixed to said mainframe;
at least one angular fixing structure, fixed to said support base, having a steel ball exposed by said angular fixing structure; and
a rotation top, connected to said support base, said rotation top having a steel ball slot supported by said steel ball.

8. The rotation hinge module of claim 7, wherein said rotation top further comprises another rotation hinge to connect with said display module.

9. The rotation hinge module of claim 7, wherein said support base further comprises:
an elastic means, connected to said angular fixing structure; and
a ball cover, having an opening, disposed over said steel ball and secured to said angular fixing structure.

10. The rotation hinge module of claim 7, further comprising an upper friction ring and a lower friction ring respectively fixed to said support base and said rotation top.

11. The rotation hinge module of claim 7, wherein said support base further comprises a plurality of holes for fastening.

12. The rotation hinge module of claim 7, wherein said support base further comprises a blocker and said rotation top further comprises a positioner, said rotation top having a rotation range in relation to said support base because said blocker limits said positioner.

13. A rotation hinge module with angular fixing function is employed to connect a mainframe and a display module of a notebook computer, said rotation hinge module comprising:
a support base, fixed to said mainframe and having at least one support structure and a blocker;
an elastic means, connected to said support structure;
a steel ball, located on said elastic means;
a ball cover, having an opening, disposed over said steel ball and secured to said support structure, said steel ball partially exposed by said ball cover through said opening; and
a rotation top, connected to said support base, said rotation top having a positioner and a steel ball slot supported by said partially exposed steel ball, wherein said rotation top has a rotation range in relation to said support base because said blocker limits said positioner.

14. The rotation hinge module of claim 13, wherein a diameter of said opening is smaller than a diameter of said steel ball.
